(19) United States
(12) Patent Application Publication
(10) Pub. No.: US 2018/0165693 A1
(43) Pub. Date: Jun. 14, 2018

(54) METHODS AND SYSTEMS TO DETERMINE CORRELATED-EXTREME BEHAVIOR CONSUMERS OF DATA CENTER RESOURCES

(71) Applicant: VMware, Inc., Palo Alto, CA (US)

(72) Inventors: Lalit Jain, Palo Alto, CA (US); Janislav Jankov, Sofia (BG)

(73) Assignee: VMware, Inc., San Jose, CA (US)

(21) Appl. No.: 15/377,824

(22) Filed: Dec. 13, 2016

(51) Int. Cl. G06Q 30/02; G06F 9/455

(52) U.S. Cl. CPC G06Q 30/0201; G06F 9/45533

(57) ABSTRACT

Methods and systems that identify objects of a data center that exhibit correlated-extreme behavior are described. The objects may be, but are not limited to, virtual machines (“VMs”), containers, server computers, clusters of server computers, and the data center itself. Metric data is collected for the various objects and the methods identify the objects that exhibit correlated-extreme behavior. In particular, the methods and systems narrow a search for correlated-extreme behavior of consumers of computational resources of a data center when a provider of the computational resources exhibits unexpected or extreme behavior.

### TECHNICAL FIELD

The present disclosure is directed to identifying consumers of a data center resources that exhibit correlated-extreme behavior.

### BACKGROUND

During the past several decades, electronic computing has evolved from primitive, vacuum-tube-based computer systems, initially developed during the 1940s, to modern electronic computing systems in which large numbers of multi-processor server computers are networked together with large-capacity data-storage devices and other electronic devices that are housed and maintained in facilities called “data centers” in order to provide enormous computational bandwidths and data-storage capacities. Data centers are made possible by advances in computer networking, distributed operating systems and applications, data-storage appliances, computer hardware, and software technologies. Certain server computers may also be networked together to form computer clusters. The applications are typically run in a data center as a virtual machine (VM) or in a container. For example, a server computer may be used to host one or more applications as VMs or in a container. As a result, many thousands of applications may be run in just one data center.

At present, data centers use automated information technology (IT) management tools to record and monitor the performance of different types of “objects” of the data center and generate alerts when a particular resource of an object is congested. The VMs, containers, server computers, computer clusters, and data center itself are objects. Average-CPU utilization, CPU-contention, and average-memory utilization are examples of metrics that are typically used to monitor the performance of different types of objects. Typical IT management tools relay on predictive models to calculate fixed or dynamic metric thresholds based on historical metric data. When current metric data violates a corresponding fixed or dynamic threshold, an alert may be generated. However, one disadvantage of relying on historical metric data is that historical metric data may not correlate with the most recently produced metric data. As a result, fixed and dynamic thresholds that are created based on historical metric data may not consistently identify current resource congestion.

### SUMMARY

Data center managers seek analytical tools that identify consumers of data center resources responsible for causing alerts based on current or most-recent metric data. This disclosure is directed to methods and systems that identify objects of data center resources that exhibit correlated-extreme behavior. The objects may be, but are not limited to, virtual machines (VMs), containers, server computers, clusters of server computers, and the data center itself. The terms “consumer” and “provider” are relative terms that indicate the relationships between the different types of data center objects. For example, VMs are consumers with respect to a server computer that host the VMs. In this case the server computer is a provider of computational resources to the consumers. A server computer is a consumer with respect to a computer cluster of which the server computer is a part. The VMs, server computers, and computer clusters are all consumers with respect to a data center that houses and maintains these systems. Metric data is collected for the various objects and the methods identify the consumers that exhibit correlated-extreme behavior at the provider. The methods search for correlated-extreme behaving objects at the consumer level when the provider exhibits unexpected or extreme behavior. A potential application is when a data center management tool triggers an alert at a provider. Correlated extreme behavior detection methods may be used to identify one or more consumers of the provider resources contributing to the alert. As a result, system administrators may be able to find a root cause of the problem and fix the problem when the alert is triggered.

### DESCRIPTION OF THE DRAWINGS

FIG. 1 shows a general architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machine and virtual-machine execution environments.

FIG. 6 shows an example of an open virtualization format package.

FIG. 7 shows virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example of a provider and a number of consumers of the computational resources of the provider.

FIG. 12 shows an example time plot of CPU contention metric data for three virtual machines and a server computer.

FIG. 13 shows plots of metric data collected over a time period for a provider and four consumers.

FIG. 14A shows a plot of metric data values.

FIG. 14B shows a plot of a tail for the metric data values shown in FIG. 14A.

FIG. 15 shows plots of metric data of the provider and metric data of a subset of consumers correlated with the provider.

FIGS. 16A-16B show example plots of a histogram of the provider tail and a histogram of the consumer tail, respectively.

FIG. 17 shows example plots of symmetrical and asymmetrical probability density functions.

FIGS. 18A-18B show example plots of probability density functions fit to probabilities of a provider tail and a consumer tail.

FIG. 19 shows a control-flow diagram of a method to determine correlated-extreme behavior of consumers of computational resources.

FIG. 20 shows a control-flow diagram of the routine “identify consumers correlated with the provider” called in FIG. 19.

FIG. 21 shows a control-flow diagram of the routine “determine a consumer cumulative distribution” called in FIG. 19.

FIG. 22 shows a control-flow diagram of the routine “determine a provider cumulative distribution” called in FIG. 19.

FIG. 23A-B shows a control-flow diagram of the routine “determine consumers with correlated-extreme behavior” called in FIG. 19.

### DETAILED DESCRIPTION

This disclosure presents computational methods and systems that identify consumers of computational resources in a data center as exhibiting correlated-extreme behavior with computational resource providers of the data center. In a first subsection, computer hardware, complex computational systems, and virtualization are described. Methods and systems that identify consumers that exhibit correlated extreme behavior are described below in a second subsection.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

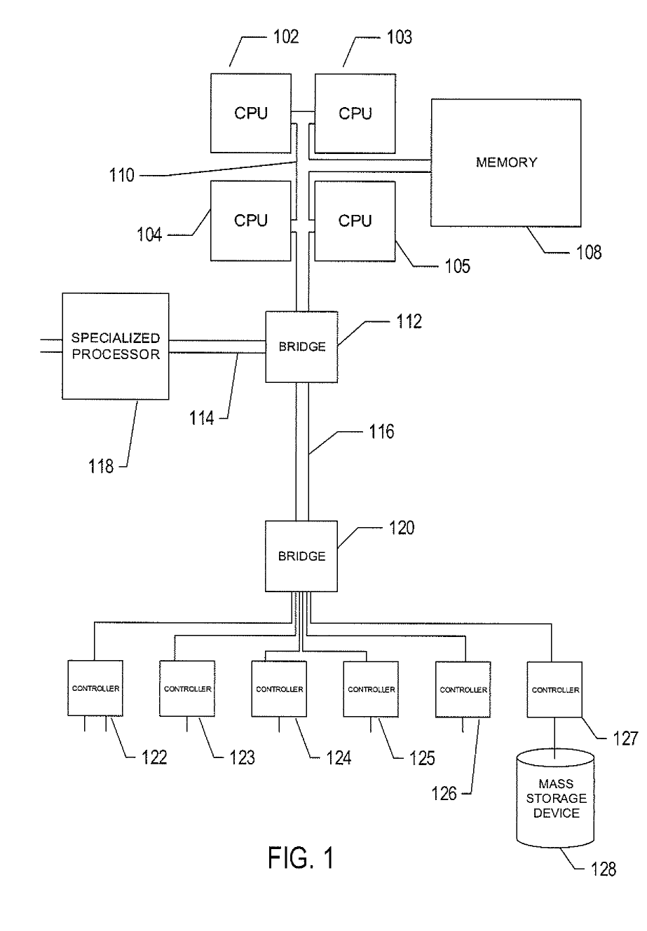

FIG. 1 shows a general architectural diagram for various types of computers. Computers that receive, process, and store event messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

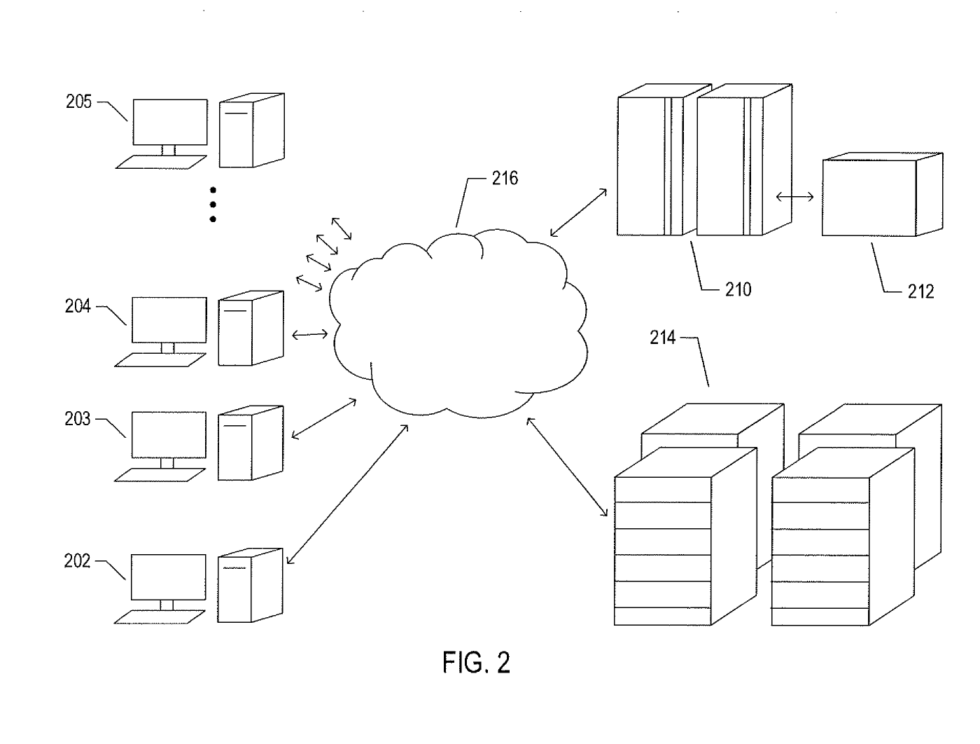

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

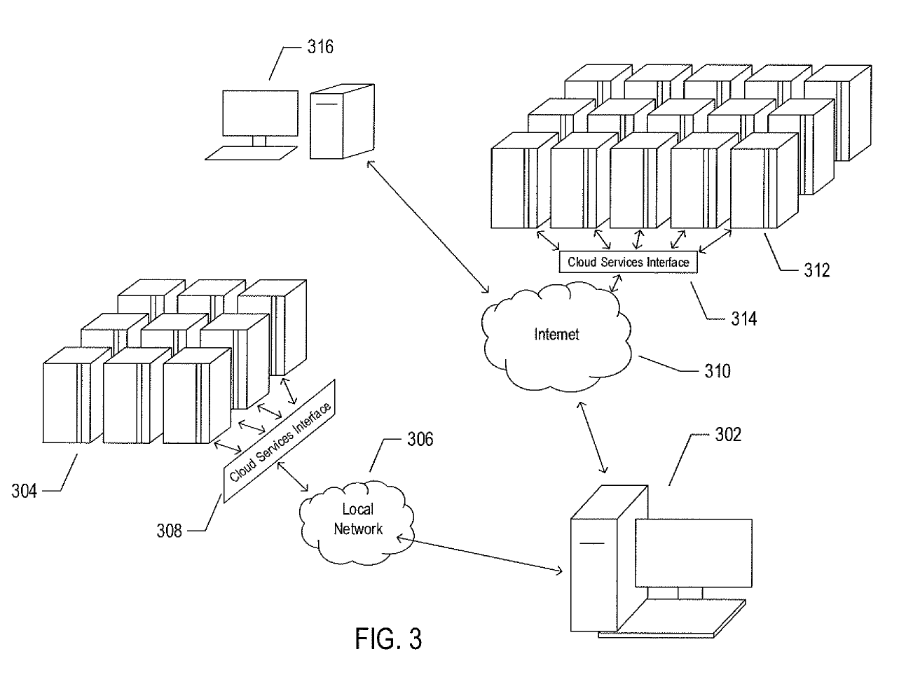

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

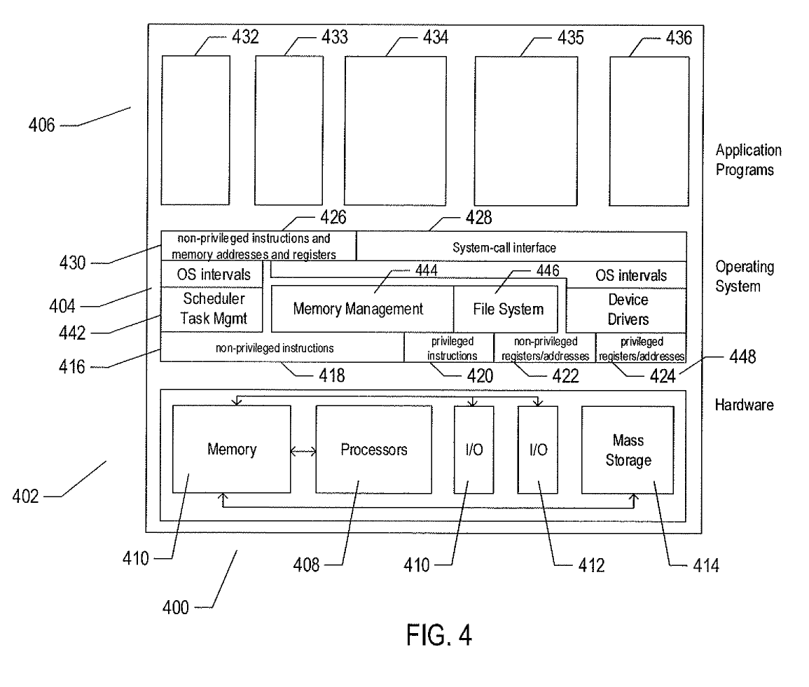

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

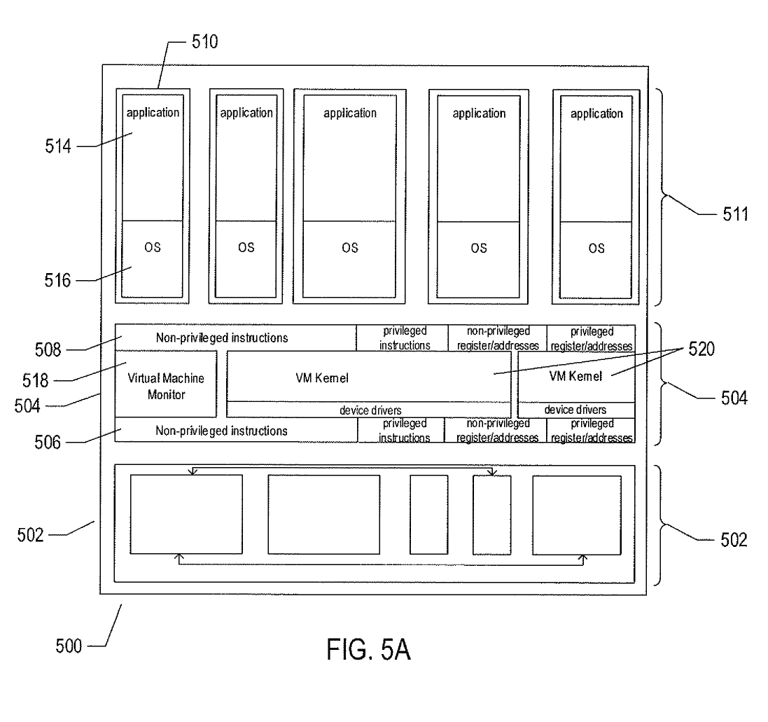

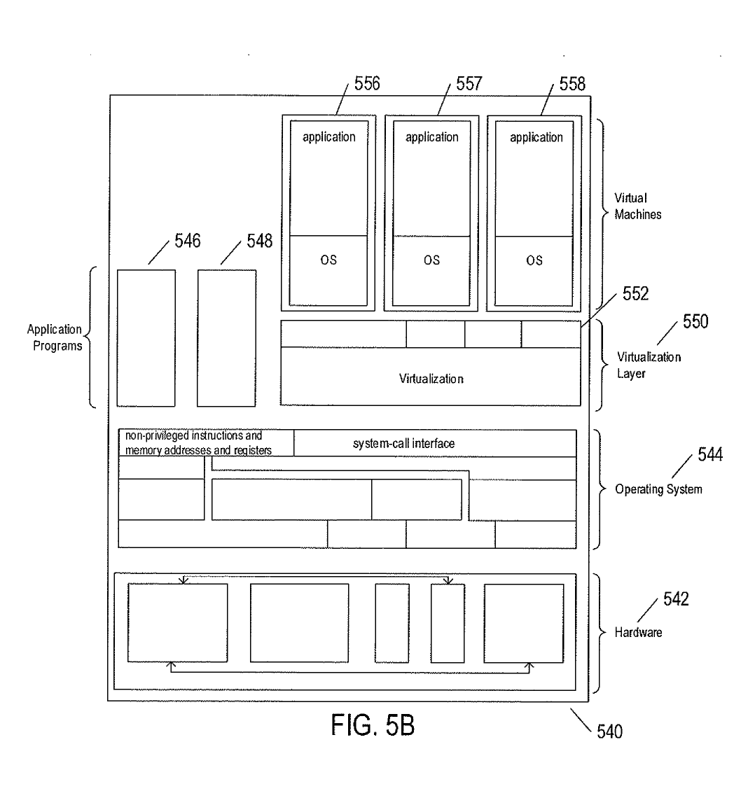

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in Figure SA features a virtualization layer 504 that interfaces through a virtualization-layer/hardware-layer interface 506, equivalent to interface 416 in FIG. 4, to the hardware. The virtualization layer 504 provides a hardware-like interface 508 to a number of VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization-layer interface 508 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization-layer interface 508 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization-layer interface 508, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

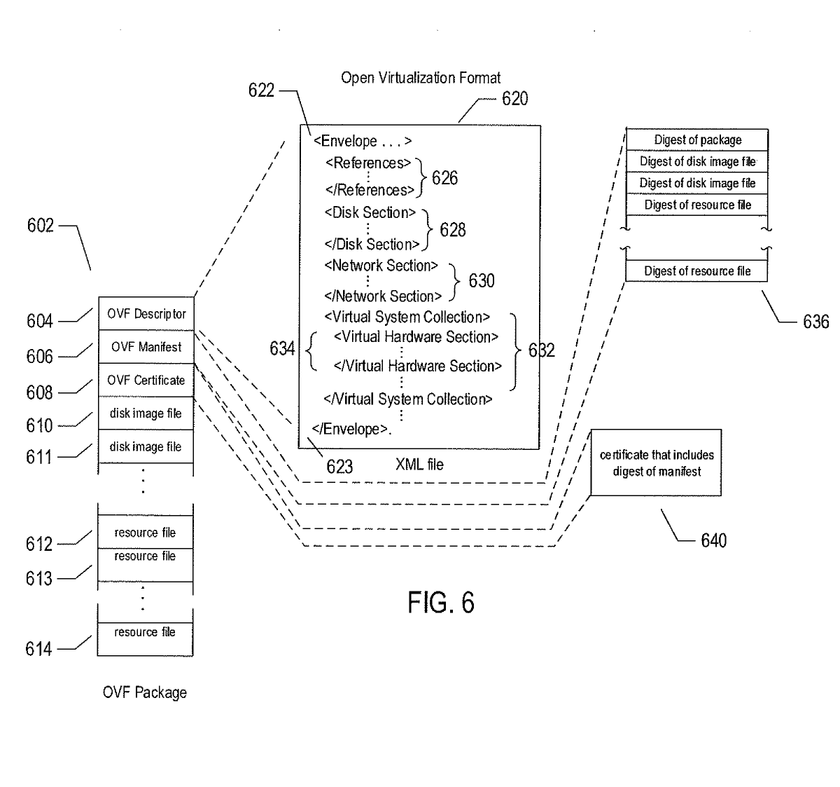

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or entirely eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

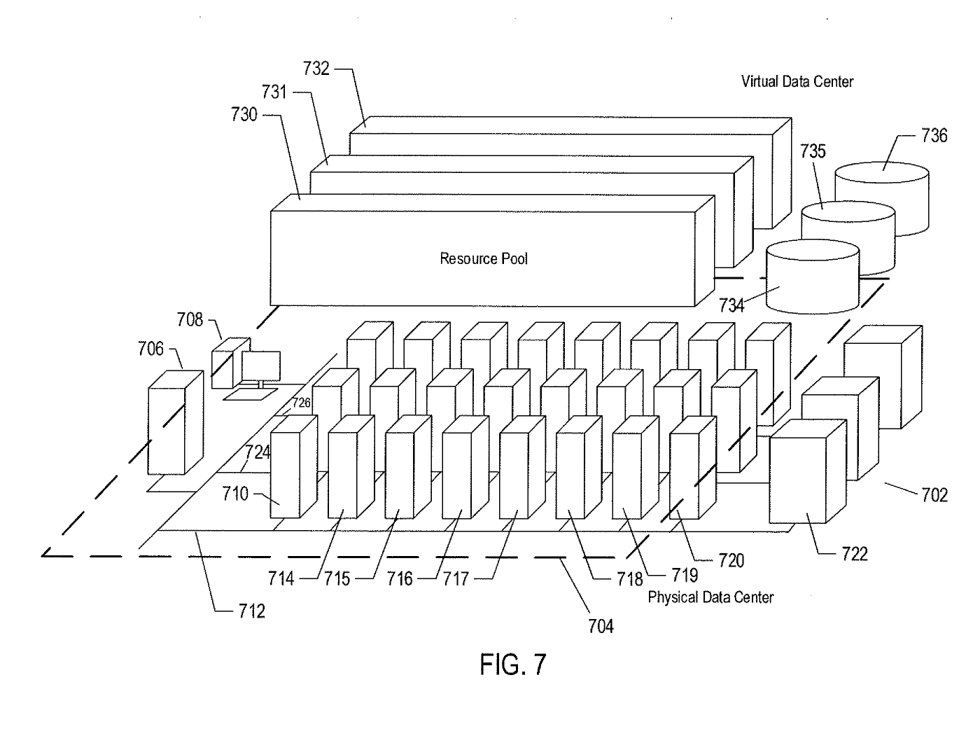

FIG. 7 shows virtual data centers provided as an abstraction of underlying physical-data-center hardware components. In FIG. 7, a physical data center 702 is shown below a virtual-interface plane 704. The physical data center consists of a virtual-data-center management server 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of physical servers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server 706 includes functionality to migrate running VMs from one physical server to another in order to optimally or near optimally manage device allocation, provide fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual physical servers and migrating VMs among physical servers to achieve load balancing, fault tolerance, and high availability.

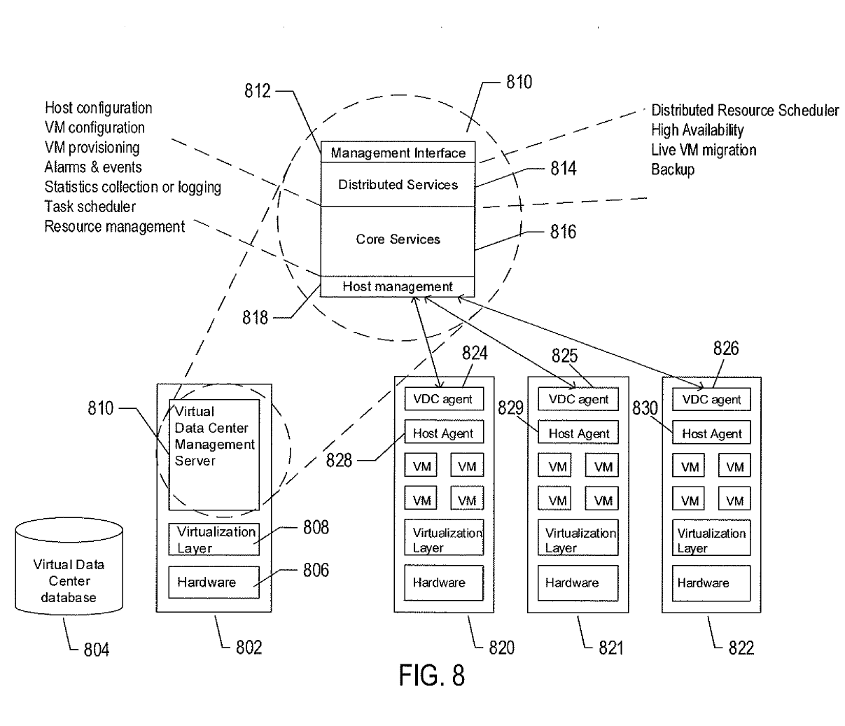

FIG. 8 shows virtual-machine components of a virtual-data-center management server and physical servers of a physical data center above which a virtual-data-center interface is provided by the virtual-data-center management server. The virtual-data-center management server 802 and a virtual-data-center database 804 comprise the physical components of the management component of the virtual data center. The virtual-data-center management server 802 includes a hardware layer 806 and virtualization layer 808, and runs a virtual-data-center management-server VM 810 above the virtualization layer. Although shown as a single server in FIG. 8, the virtual-data-center management server (“VDC management server”) may include two or more physical server computers that support multiple VDC-management-server virtual appliances. The VM 810 includes a management-interface component 812, distributed services 814, core services 816, and a host-management interface 818. The management interface 818 is accessed from any of various computers, such as the PC 708 shown in FIG. 7. The management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the physical servers of the physical data center that is abstracted to a virtual data center by the VDC management server.

The distributed services 814 include a distributed-device scheduler that assigns VMs to execute within particular physical servers and that migrates VMs in order to most effectively make use of computational bandwidths, data-storage capacities, and network capacities of the physical data center. The distributed services 814 farther include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server, and restarts the VM on the different physical server from a virtual-machine state recorded when execution of the VM was halted. The distributed services 814 also include a distributed backup service that provides centralized virtual-machine backup and restore.

The core services 816 provided by the VDC management server 810 include host configuration, virtual-machine configuration, virtual-machine provisioning, generation of virtual-data-center alarms and events, ongoing event logging and statistics collection, a task scheduler, and a device-management module. Each physical server 820-822 also includes a host-agent VM 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce device allocations made by the VDC management server 810, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

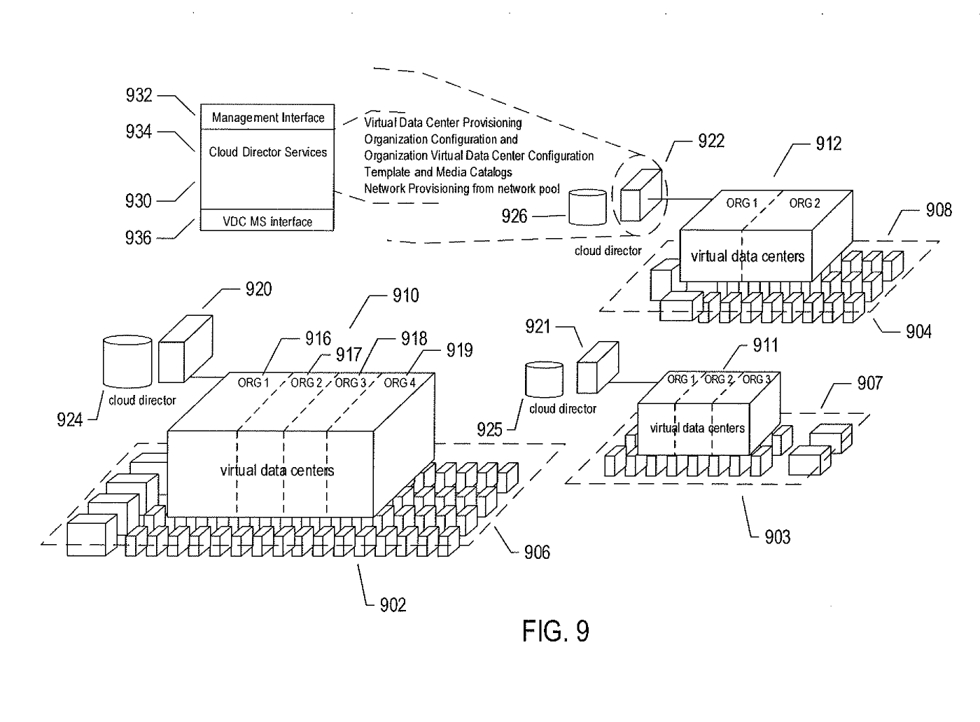

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

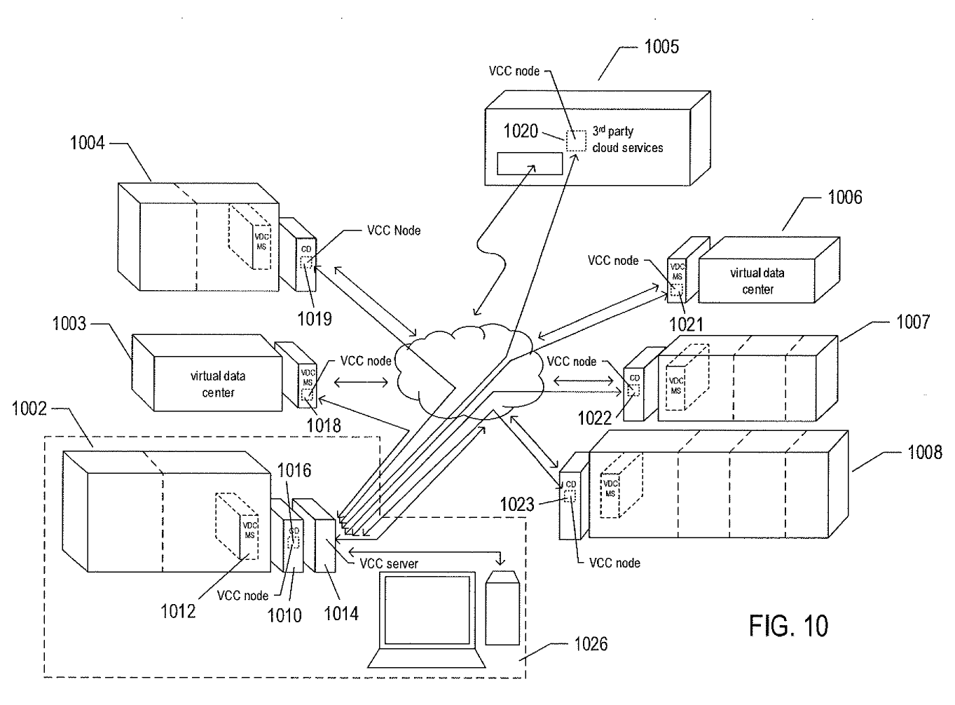

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

Methods and Systems to Determine Correlated-Extreme Behavior of Objects

In this section, methods and systems that detect objects of a data center that exhibit correlated extreme behavior based on current metric data are described. In the following description, a VM, container, a server computer, a cluster of server computers, and a data center itself are called “objects.” The terms “resource consumer,” or just “consumer” and “resource provider” or just “provider” are relative terms that are used to describe the relationships between data center objects that consume and provide computational resources of a data center. In particular, resource consumers uses computational resources of a resource provider. Examples of computational resources include, but are not limited to, CPU, memory, data storage, and network bandwidth.

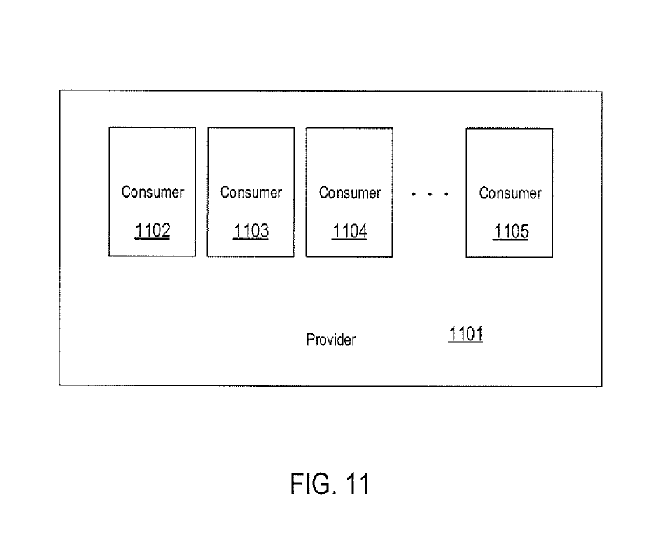

FIG. 11 shows an example of a provider 1101 and a number of consumers 1102-1105. In FIG. 11, the consumer 1102-1105 may represent VMs or containers of VMs and the provider 1101 may be a server computer, a computer cluster, or a data center. Alternatively, the consumers 1102-1105 may represent server computers and the provider 1101 may be a data center used to house and maintain the server computers. Alternatively, the consumers 1102-1105 may be computer clusters and the provider 1101 may be a data center used to house and maintain the computer clusters.

A server computer, computer cluster, or data center may exhibit unusual behavior that typically appears as spikes or peaks in one or more metric data generated by these objects. The spikes occurring in metric data of a provider result from unusual behavior of one or more consumers but does not represent the behavior of all consumers of the resources of the provider. For example, spikes in average-CPU usage metric data generated by a server computer may be the result of extreme behavior exhibited by a small number of VMs running on the server computer while the remaining VMs running on the server computer exhibit normal average-CPU usage. The VMs that exhibit extreme behavior in average-CPU usage may be responsible for CPU congestion at the server computer.

At present, many data center management tools generate an alert when a particular resource, such as CPU, memory, and network bandwidth, of an object is congested, based on metric data of the resource that violates associated hard or dynamic thresholds. However, typical management tools do not identify which consumers contribute to spikes in metric data of the provider or which consumers exhibit the highest correlated extreme behavior observed in the metric data of the provider. Typical management tools instead use predictive models to generate fixed thresholds or dynamic thresholds for each type of metric based on historical metric data and not on current metric data. An alert is triggered when the metric data of a provider violates an associated threshold. However, because historical metric data may not correlate with current metric data of provider and consumers, ad hoc hard or dynamic thresholds learned on historical metric data may not always be relied on to identify the consumers responsible for the extreme behavior of the provider. A system administrator would like to identify the one or more consumers that are likely responsible for the extreme abnormal behavior of the provider during troubleshooting.

Currently, methods that display a list of consumers that exhibit correlated-extreme behavior causing an alert associated with a provider or when unusual behavior occurs at the provider do not exist. The only way an administrator is currently able to identify correlated-extreme behaving consumers is by setting up a metrics dashboard, constantly monitor each object's metrics and visually attempting to identify which consumers correlate with the unusual behavior of the provider. In general, a manual approach to tracking the behavior of a provider and its consumers based on visual inspection of metric data is not effective in a cloud computing environment due to the extremely large volume of workloads.

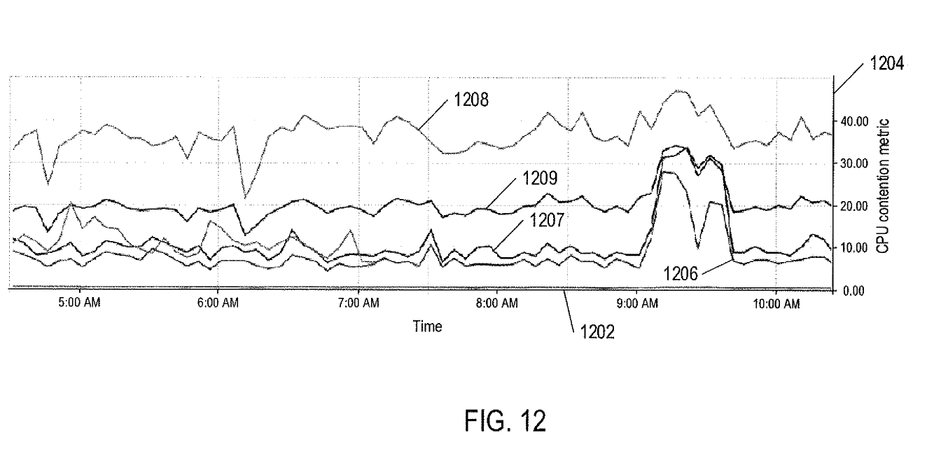

FIG. 12 shows a time plot of CPU contention metric data for three VMs and a server computer that host the VMs. Horizontal axis 1202 represents a period of time. Vertical axis 1204 represents a CPU contention metric. Curves 1206, 1207, and 1208 represent CPU contention metric data collected for the three VMs over the period of time. Curve 1209 represents CPU contention metric data for the server computer over the period of time. A systems administrator manually looks at the plot of the CPU contention metrics of the VMs in an attempt to troubleshoot extreme behavior. This process is time consuming and error prone because it is difficult to correlate extreme behavior at the VMs and with extreme behavior at the provider across a specific time period. This approach is further complicated when there are thousands of VMs running on the same host or server computer and there are many different types of metrics to consider. As a result, this approach to trouble shoot is difficult to employ in real time scenarios.

Methods described below are directed to analytics tools that may be used to identify the consumers causing alerts at a provider based on current or most-recent metric data. The root cause of the extreme behavior at the provider may be determined by identifying extreme behavior in the one or more consumers that is correlated with the extreme behavior of the provider. Methods identify extreme behavior in the consumers that correlates with the extreme behavior at the provider based on current or most recent metric data. Identifying a set of consumers with correlated extreme behavior to that of the provider enables a system administrator to take precautionary measures to avoid the problems and alerts in the future. In addition, even if an alert is triggered by metric data of a provider or a provider crashes, a list of consumers with correlated metric data to the provider may be used to investigate one or more root causes of these issues.

Because extreme abnormal behavior at a provider may only be created by a small number of consumers, the metric data of consumers that do not correlate with the metric data of the provider are filtered out in order to focus attention on the consumers with metric data that correlates with the metric data of the provider. The set of metric data of a provider collected over a period of time [t₁, t_{T}] is represented by

$${M}_{P} = {\{ {M}_{P , j} \}}_{j = 1}^{{X}_{P}} \qquad ( 1 )$$

where
M_{P,j}=Metric_{P}(tⱼ) is a metric data value of the provider at time stamp tⱼ; subscript j is a time stamp index j=1, . . . , X_{P}; and
X_{P} is the number of metric data values collected in the period of time [t₁, t_{T}].
   The metric data of each consumer collected over the same period of time [t₁, t_{T}] is represented by

$${M}_{{C}_{n}} = {\{ {M}_{{C}_{n} , j} \}}_{j = 1}^{{X}_{n}} \qquad ( 2 )$$

where
M_{C}_{ₙ}_{,j}=Metric_{C}(tⱼ) is a metric data value of the nth consumer at the time stamp tⱼ;
subscript Cₙ represents the nth consumer;
subscript n is a consumer index n=1, . . . , N;
N is the number of consumers; and
Xₙ is the number of metric data values in the set of metric data M_{C}_{ₙ} collected in the period of time [t₁, t_{T}].
   The period of time [t₁, t_{T}] may be a recent or current period of time and the time t_{T} may represent the time when the method is started to determine which consumers of computational resources of a provider exhibit correlated-extreme behavior with the provider. Alternatively, the time t_{T} may represent the time of a most recent alert generated by the provider.

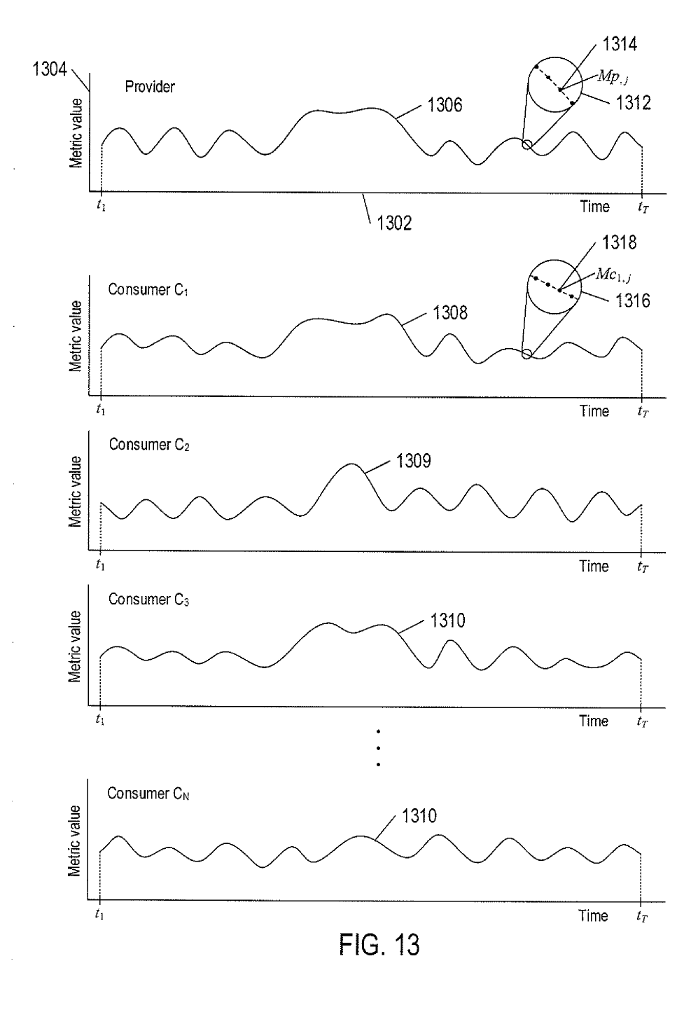

FIG. 13 shows plots of metric data collected over a time period for a provider and four consumers of N consumers. Horizontal axes, such as horizontal axis 1302, each represent time. Vertical axes, such as vertical axis 1304, each represent a range of metric values. Curve 1306 represents as a set of metric data M_{P} collected for the provider over a period of time [t₁, t_{T}]. Curves 1308-1311 represent sets of metric data M_{C}_{₁}, M_{C}_{₂}, M_{C}_{₃}, . . . , M_{C}_{_{N}} collected for the four consumers over the same period of time [t₁, t_{T}]. The time t₁ represents an initial time stamp and time t_{T} represents a final time stamp of the period of time over which the metric data is collected. The metric data represented by curves 1306 and 1308-1311 are the same type of metric data. For example, sets of metric data M_{P}, M_{C}_{₁}, M_{C}_{₂}, M_{C}_{₃}, . . . , M_{C}_{_{N}} may be average-CPU usage, CPU contention, or average memory usage. The metric data values of the provider and the consumers are collected at substantially the same time stamp tⱼ within the period of time. For example, a magnified view 1312 of the curve 1306 shows four metric data values represented by dots, such as dot 1314. A magnified view 1316 of the curve 1308 shows four metric data values represented by dots, such as dot 1318. The metric data values represented by dots in magnified views 1312 and 1316 are collected at the same time stamps. For example, the metric data value M_{P,j} of the provider is collected at the same time stamp tⱼ as the metric data value M_{C}_{₁}_{,j} of consumer C₁.

Correlation filtering is carried out as an initial screening in order to identify any consumers that are correlated with the provider. Correlation filtering is accomplished by calculating a correlation coefficient for each consumer (i.e., for n=1, . . . , N) and the provider as follows:

$$ρ ( {C}_{n} , P ) = \frac{{\sum }_{j = 1}^{{X}_{n}} ( {M}_{{C}_{n} , j} - {\overline{M}}_{{C}_{n}} ) ( {M}_{P , j} - {\overline{M}}_{P} )}{\sqrt{{\sum }_{j = 1}^{{X}_{n}} {( {M}_{{C}_{n} , j} - {\overline{M}}_{{C}_{n}} )}^{2}} \sqrt{{\sum }_{j = 1}^{{X}_{n}} {( {M}_{P , j} - {\overline{M}}_{P} )}^{2}}} \\ where \\ {\overline{M}}_{{C}_{n}} = \frac{1}{T} {\sum }_{j = 1}^{{X}_{n}} {M}_{{C}_{n} , j} ; and \\ {\overline{M}}_{P} = \frac{1}{T} {\sum }_{j = 1}^{{X}_{n}} {M}_{P , j} . \qquad ( 3 )$$

The correlation coefficient indicates the degree to which metric data of a consumer is related to the metric data of the provider. The absolute value of the correlation value calculated for each consumer is then compared with a correlation threshold, Th_{cor}, where 0<Th_{cor}≤1, in order to identify the consumers with metric data that are more closely correlated with or closely related to the metric data of the provider than other consumers. When the following condition is satisfied:

|ρ(Cₙ,P)|>Th_{cor} (4a)

the consumer Cₙ is identified as being correlated with the provider. On the other hand, when the following condition is satisfied:

|ρ(Cₙ,P)|≤Th_{cor} (4b)

the consumer Cₙ is considered not correlated with the provider and is filtered out or no longer considered for further analysis. The correlated consumers comprise a smaller set of consumers than the full set of consumers associated with provider as represented by:

C={Cₖ}ₖ₌₁^{K}⊆{Cₙ}n=₁^{N} (5)
where
   Cₖ represents a consumer with a set of metric data that satisfies the condition of Equation (4a);
   C represents the set of consumers that satisfy the condition of Equation (4a); and
   K≤N.
      The set of metric data of each consumer that is correlated with the metric data of the provider is represented by

$${M}_{{C}_{k}} = {\{ {M}_{{C}_{k} , j} \}}_{j = 1}^{{X}_{k}} \qquad ( 6 )$$

where Xₖ is the number of metric data values of in the set of metric data M_{C}_{ₖ}.

The sets of metric data of each consumer that is correlated with the metric data of the provider are combined to form a set of correlated consumer metric data given by

$${M}_{C} = {{⋃}_{k = 1}}^{K} {M}_{{C}_{k}} \qquad ( 7 )$$

Data tails of the set of provider metric data M_{P} and the set of correlated consumer metric data M_{C} are calculated for a number of different quantiles. A quantile denoted by q_{c} is the c-th quantile of the time-series metric data values and the quantile index c is a number selected from a subinterval cₘᵢₙ≤c≤cₘₐₓ of the interval [0,1]. For example, a subinterval 0.9≤c≤0.99 may be used to select values for the quantile index c. For each quantile index c, the data tail for the provider metric data M_{P} comprises distances that satisfy the following condition

dⱼ^{c}=M_{P,j}−q_{c}>0 (8a)

for j=1, . . . , T_{P}. In other words, the provider data tail comprises distances for data points M_{P,j} greater than the quantile q_{c} (i.e., M_{P,j}>q_{c}). The provider tail of the set of metric data M_{P} for the c-th quantile q_{c} is represented by

$${Tail}_{P}^{c} = {\{ {d}_{P , j}^{c} \}}_{j = 1}^{{T}_{P}} \qquad ( 8 b )$$

where T_{P} is the number of metric data values in M_{P} that satisfy the condition of Equation (8a).

Note that T_{P} is less than or equal to X_{P} because not all metric data values in M_{P} may satisfy the condition of Equation (8b). For each quantile index c, the data tail for the consumer metric data M_{C} comprises distances that satisfy the following condition

d_{C}_{ₖ}_{,j}^{c}=M_{C}_{ₖ}_{,j}−q_{c}>0 (9a)

for j=1, . . . , T_{K} and k=1, . . . , K. The consumer tail of the set of correlated consumer metric data M_{C} for the c-th quantile q_{c} is represented by

$${Tail}_{C}^{c} = {⋃}_{k = 1}^{K} {\{ {d}_{{C}_{k} , j}^{c} \}}_{j = 1}^{{T}_{k}} \qquad ( 9 b )$$

where Tₖ is the number of metric data values in M_{C}_{ₖ} that satisfy the condition of Equation (9a).

Note that Tₖ is less than or equal to Xₖ because not all metric data values in M_{C}_{ₖ} may satisfy the condition of Equation (9b).

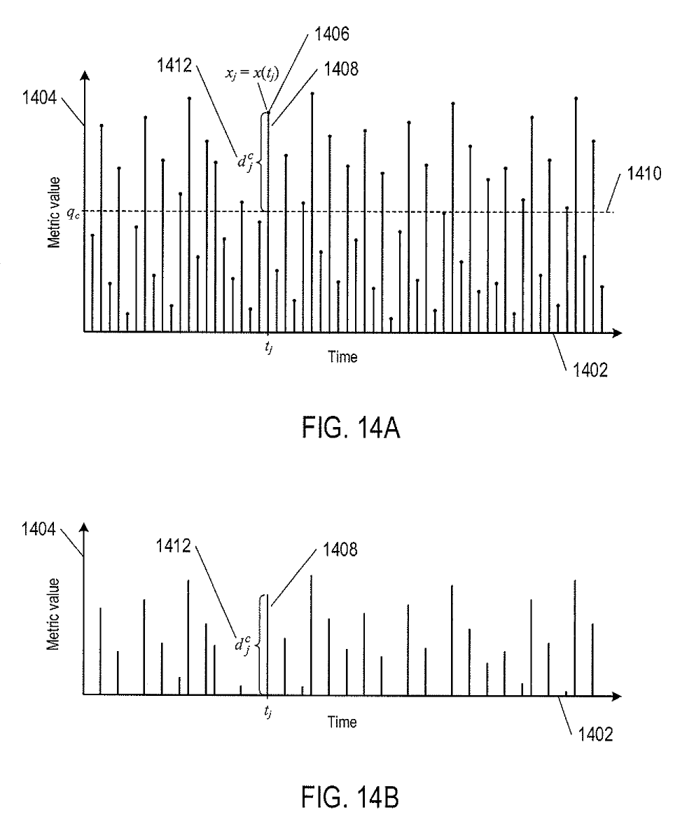

FIG. 14A shows an example plot of a set of data. Horizontal axis 1402 represents time. Vertical axis 1404 represents metric values. Solid dots, such as dot 1406, represent a metric data value recorded at a point in time. Lines, such as line 1408, that extend from the time axis 1402 to the metric data values represent the magnitudes of the metric data values. Dashed line 1410 represents the c-th quantile q_{c}. The distance of the point 1406 above the quantile q_{c} is given by dⱼ^{c} 1412. The set of distances dⱼ^{c} above the quantile q_{c} is a data tail for the quantile q_{c}.

FIG. 14B shows an example plot of a data tail that comprises the distances above the quantile q_{c} 1410 in FIG. 14A. Horizontal axis 1402 represents time. Vertical axis 1404 represents metric data values. Line segments that extend from the time axis 1402 represent the distances calculated according to Equation (8). For example, line 1412 represents the distance dⱼ^{c} of the metric data point 1406, in FIG. 14A, above the quantile 1410 shown in FIG. 14A. The distances shown in FIG. 14B are collected to form a data tail associated with the c-th quantile 1410 for the time-series data shown in FIG. 14A.

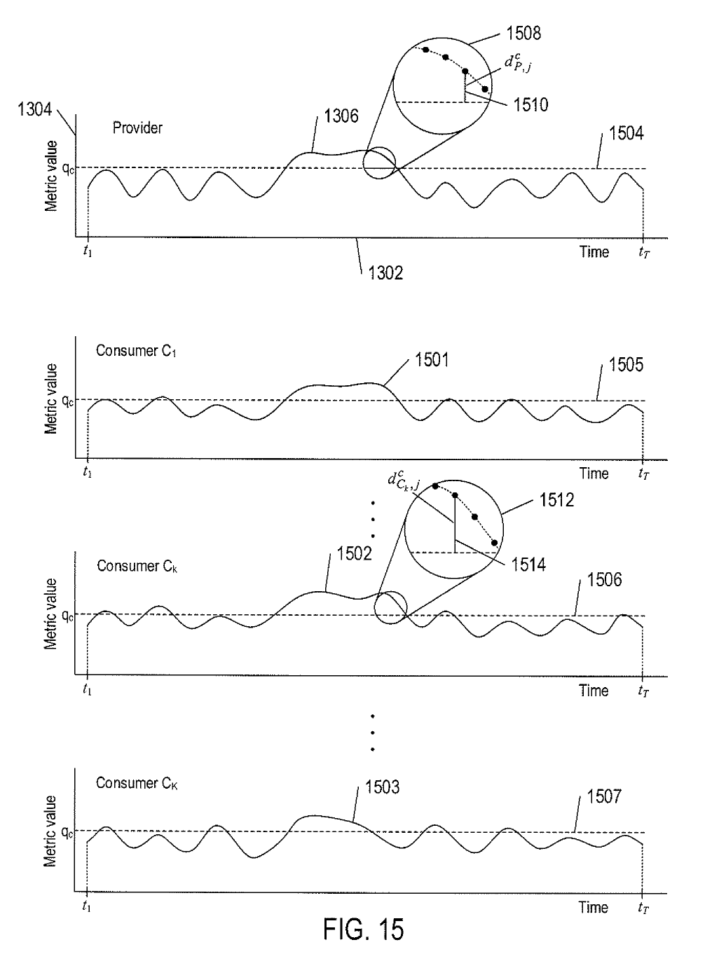

FIG. 15 shows plots of metric data of the provider and metric data of a subset of consumers that satisfy the correlation condition of Equation (4a). Curves 1501-1503 represent sets of metric data of three consumers that satisfy the correlation condition of Equation (4a). Dashed lines 1504-1507 represent quantiles q_{c} determined for the sets of provider and consumer metric data. As shown in enlarged view 1508 of FIG. 15, a line 1510 represents a tail value d_{P,j}^{c} from the metric data value M_{P,j} to the quantile q_{c}, where M_{P,j}>q_{c}. As show in enlarged view 1512 of FIG. 15, line 1514 represents a tail value from the metric data value M_{C}_{ₖ}_{,j} to the quantile q_{c}, where M_{C}_{ₖ}_{,j}>q_{c} for the consumer Cₖ.

Tails are determined for a number of quantile indices c selected from the subinterval cₘᵢₙ≤c≤cₘₐₓ. For example, when the quantile index c is confined to the subinterval 0.9≤c≤0.99, provider and consumer data tails may be determined for quantile indices separated by tenths, hundredths or thousands. For example, consumer and provider tails may be determined for c equal to 0.90, 0.91, 0.92, 0.93, 0.94, 0.95, 0.96, 0.97, 0.98, and 0.99. The provider tails are determined for each value of c as described above with reference to Equation (8b). For quantile indices separated by tenths, the provider tails are Tail_{P}^{0.90}, Tail_{P}^{0.91}, Tail_{P}^{0.92}, Tail_{P}^{0.93}, Tail_{P}^{0.94}, Tail_{P}^{0.95}, Tail_{P}^{0.96}, Tail_{P}^{0.97}, Tail_{P}^{0.98}, and Tail_{P}^{0.99}. The consumer tails are determined for each value of c as described above with reference to Equation (9b). For quantile indices separated by tenths, the consumer tails are Tail_{C}^{0.90}, Tail_{C}^{0.91}, Tail_{C}^{0.92}, Tail_{C}^{0.93}, Tail_{C}^{0.94}, Tail_{C}^{0.95}, Tail_{C}^{0.96}, Tail_{C}^{0.97}, Tail_{C}^{0.98} and Tail_{C}^{0.99}.

For each value of the quantile index c in the subinterval cₘᵢₙ≤c≤cₘₐₓ, a histogram is created for the provider tail Tail_{P}^{c} and a histogram is created for the consumer tail Tail_{P}^{c}. A histogram is generated by dividing the range of metric values into R bins. Each bin represents an interval of metric values in the range of metric values. The number of data tails values are counted within each bin of the provider tail Tail_{P}^{c}, where nᵣ^{P} is the number of data tail values in the r-th bin. The number of data tails values are counted within each bin of the consumer Tail_{C}^{c}, where nᵣ^{C} is the number of data tail values in the r-th bin.

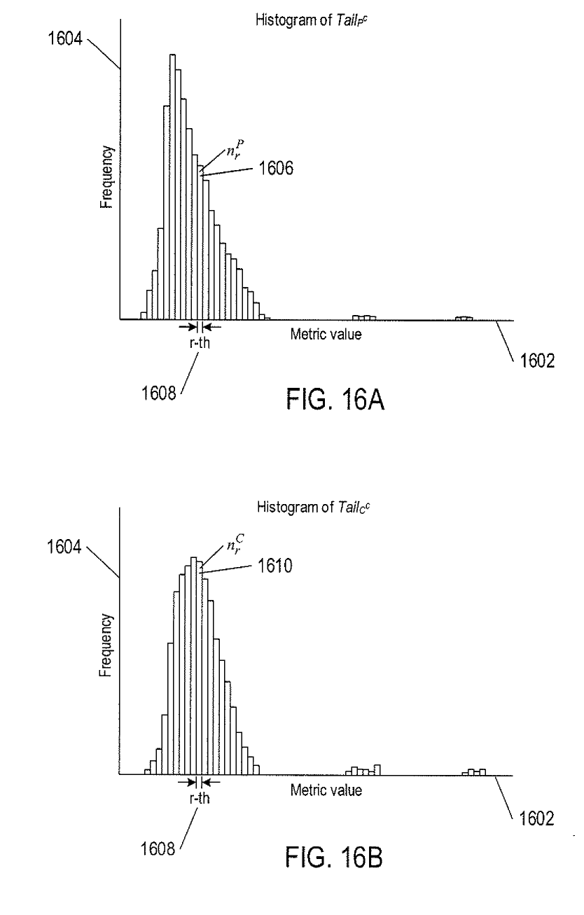

FIGS. 16A-16B show example plots of a histogram of a provider tail Tail_{P}^{c} and a histogram of a consumer tail Tail_{C}^{c}, respectively, obtained for the same quantile q_{c}. Horizontal axes 1602 represent a range of metric tail values. Vertical axes 1604 represent a range of frequencies or number of tail values that are within a bin of metric tail values. For example, a bar 1606 represents the number of provider tail values nᵣ^{P} (i.e., frequency) that lie within r-th bin 1608 of the metric tail values, and a bar 1610 represents the number of consumer tail values nᵣ^{C} (i.e., frequency) that lie within the same r-th bin 1608.

A probability is calculated for each bin of the histogram of the provider tail Tail_{P}^{c} as follows:

$${p}_{P}^{r} = \frac{{n}_{r}^{P}}{{n}_{P}} \qquad ( 10 a )$$

where nₚ=Σᵣ₌₁^{R}nᵣ^{P}.

A probability is also calculated for each bin of the histogram of the consumer tail Tail_{C}^{c} as follows:

$${p}_{C}^{r} = \frac{{n}_{r}^{C}}{{n}_{C}} \qquad ( 10 b )$$

where n_{C}=Σᵣ₌₁^{R}nᵣ^{C}.

Uncertainty is measured for the provider tail Tail_{P}^{c} by calculating the entropy as follows:

$$H ( {Tail}_{P}^{c} ) = - {\sum }_{r = 1}^{R} {p}_{P}^{r} {log}_{R} ( {p}_{P}^{r} ) \qquad ( 11 a )$$

Uncertainty is measured for the consumer tail Tail_{C}^{c} by calculating the entropy as follows:

$$H ( {Tail}_{C}^{c} ) = - {\sum }_{r = 1}^{R} {p}_{C}^{r} {log}_{R} ( {p}_{C}^{r} ) \qquad ( 11 b )$$

For each value of the quantile index c selected from the subinterval cₘᵢₙ≤c≤cₘₐₓ, entropies are calculated for the provider tail and for the consumer tail according to Equations (11a) and (11b), respectively. A set of entropies for the provider tails are given by:

{H(Tail_{P}^{c})}_{c=c}_{ₘᵢₙ}^{c}^{ₘₐₓ} (12a)

A set of entropies for the consumer tails are given by:

{H(Tail_{C}^{c})}_{c=c}_{ₘᵢₙ}^{c}^{ₘₐₓ} (12b)

For example, when the quantile index c is separated by tenths in the subinterval 0.9≤c≤0.99, the entropies for the provider tails are calculated according to Equation (12a) in order to obtain the following uncertainties H(Tail_{P}^{0.90}), H(Tail_{P}^{0.91}), H(Tail_{P}^{0.92}), H(Tail_{P}^{0.93}), H(Tail_{P}^{0.94}), H(Tail_{P}^{0.95}), H(Tail_{P}^{0.96}), H(Tail_{P}^{0.97}), H(Tail_{P}^{0.98}), and H(Tail_{P}^{0.99}). Likewise, the entropies for the consumer tails are calculated according to Equation (12b) in order to obtain the following uncertainties H(Tail_{C}^{0.90}), H(Tail_{C}^{0.91}), H(Tail_{C}^{0.92}), H(Tail_{C}^{0.93}), H(Tail_{C}^{0.94}), H(Tail_{C}^{0.95}), H(Tail_{C}^{0.96}), H(Tail_{C}^{0.97}), H(Tail_{C}^{0.98}), and H(Tail_{C}^{0.99}).

In one embodiment, a largest pair of entropies in the sets of Equations (12a) and (12b) for the same quantile index c are identified. The provider and consumer tails that correspond to the largest pair of entropies in the sets of Equations (12a) and (12b) are denoted by Tail_{P,max}^{c} and Tail_{C,max}^{c}, respectively. The data tails Tail_{P,max}^{c} and Tail_{C,max}^{c} are the most random data tail distributions and are referred to as the maximum entropy provider and consumer data tails, respectively. In another embodiment, the largest pair of entropies in the sets of Equations (12a) and (12b) may be identified without consideration for the quantile index. In other words, the maximum entropy provider tail and maximum entropy consumer tail that correspond to the largest pair of entropies in the sets of Equations (12a) and (12b) are denoted by Tail_{P,max}^{c} and Tail_{C,max}^{c}′, respectively, where the quantile indices c and c′ may be different.

A probability density function is fit to the probabilities of the maximum entropy provider tail Tail_{P,max}^{c} and a probability density function is fit to the probabilities of the maximum entropy consumer tail Tail_{C,max}^{c}′. The probability density functions may be skewed or asymmetrical.

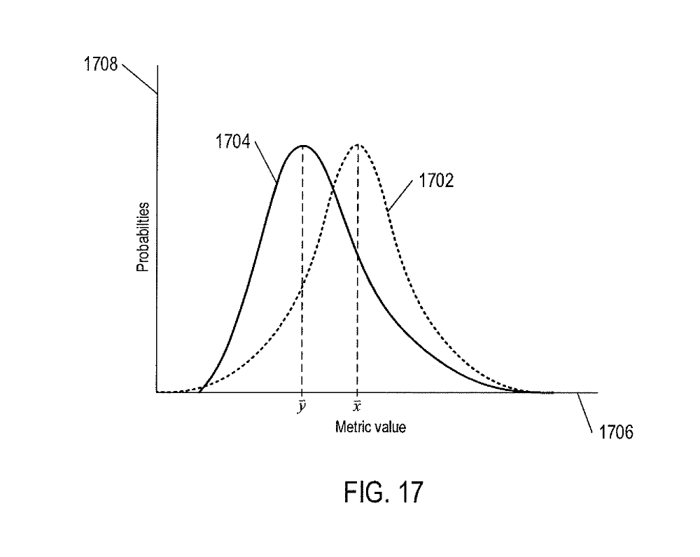

FIG. 17 shows an example of plot of a symmetrical probability density function represented by dashed curve 1702 and an asymmetrical probability density function represented by a solid curve 1704. Horizontal axis 1706 represents a range of metric values. Vertical axis 1708 represents a range of probabilities. The symmetrical density function 1702 represents a symmetrical distribution with respect to a mean value x̅. By contrast, the asymmetrical density function 1704 represents an asymmetrical distribution with respect to a mean value y̅. In this example, the asymmetrical density function 1704 is positively skewed toward larger metric tail values.

Examples of asymmetrical probability density functions that may be fit to the probabilities of the maximum entropy provider tail Tail_{P,max}^{c} and the maximum entropy consumer tail Tail_{C,max}^{c}′ include, but are not limited to, a Gumbel density function, a Frechet density function, and a Weibull density function. The Gumbel density function is given by

$$p ( x ; α , β ) = \frac{1}{β} exp [ \frac{x - α}{β} - exp ( \frac{x - α}{β} ) ] \qquad ( 13 )$$

where
α is a location parameter; and
β is a scale parameter.
   The Frechet density function is given by

$$p ( x ; s , m , γ ) = \frac{γ}{s} {( \frac{x - m}{s} )}^{- 1 - γ} exp [ - {( \frac{x - m}{s} )}^{- γ} ] \qquad ( 14 )$$

where
γ is a shape parameter greater than zero;
m is a location parameter; and
s is a scale parameter.
   The Weibull density function is given by

$$p ( x ; λ , κ ) = \frac{κ}{λ} {( \frac{x}{λ} )}^{κ - 1} exp [ - {( \frac{x}{λ} )}^{κ} ] \qquad ( 15 )$$

where
κ is a location parameter; and
λ is a scale parameter.

An asymmetrical probability density functions may be selected to approximate the probabilities of the provider tail Tail_{P,max}^{c}. An asymmetrical probability density function may be selected to approximate the probabilities of the consumer tail Tail_{C,max}^{c}′. The parameters of the selected probability density function are determined by fitting the selected probability density function to the probabilities of the bins.

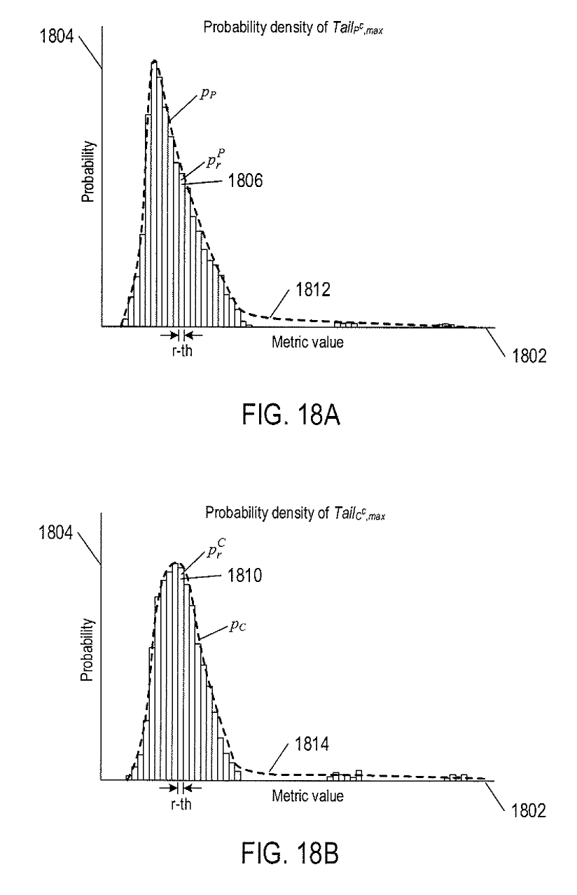

FIGS. 18A-18B show example plots of probability density functions fit to probabilities of the maximum entropy provider tail Tail_{P,max}^{c}′ and probabilities of the maximum entropy consumer tail Tail_{C,max}^{c}′. Horizontal axes 1802 represent a range of metric values. Vertical axes 1804 represent a range of probabilities. In the plots of FIGS. 18A-18B, bars present probabilities in bins determined according to Equations (10a) and (10b) determined for the provider tail Tail_{P,max}^{c}′ and the consumer tail Tail_{C,max}^{c}′. For example, a bar 1806 represents the probability pᵣ^{P} of tail values occurring in the r-th bin 1808 of the metric tail values, and a bar 1810 represents the probability pᵣ^{C} of tail values occurring in the same r-th bin 1808. Dashed curve 1812 represents a probability density function p_{P} fit to the probabilities of provider tail Tail_{P,max}^{c}. Dashed curve 1814 represents a probability density function p_{C} fit to the probabilities of consumer tail Tail_{C,max}^{c}′. The probability density functions p_{P} and p_{C} may both be Gumbel density functions, Frechet density functions, or Weibull density functions.

The parameters of the probability density functions p_{P} and p_{C} may be used to obtain the corresponding provider and child cumulative distribution functions PE_{P} and PE_{C} for the maximum entropy provider tail Tail_{P,max}^{c} and the maximum entropy consumer tail Tail_{C,max}^{c′}. For example, when the Gumbel density function is fit to the histograms of the maximum entropy provider tail and the maximum entropy consumer tail, the Gumbel cumulative distribution functions of the provider and consumers are given by

$$\begin{matrix}{PE}_{P} ( x ; {α}_{P} , {β}_{P} ) = 1 - exp [ - exp ( \frac{x - {α}_{P}}{{β}_{P}} ) ] & ( 16 a ) \\ {PE}_{C} ( x ; {α}_{C} , {β}_{C} ) = 1 - exp [ - exp ( \frac{x - {α}_{C}}{{β}_{C}} ) ] & ( 16 b )\end{matrix}$$

When the Frechet density function is fit to the probabilities of the maximum entropy provider tail and the maximum entropy consumer tail, the Frechet cumulative distributions of the provider and consumers are given by

$$\begin{matrix}{PE}_{P} ( x ; {γ}_{P} , {m}_{P} , {s}_{P} ) = exp [ - {( \frac{x - {m}_{P}}{{s}_{P}} )}^{- {γ}_{P}} ] & ( 17 a ) \\ {PE}_{C} ( x ; {γ}_{C} , {m}_{C} , {s}_{C} ) = exp [ - {( \frac{x - {m}_{C}}{{s}_{C}} )}^{- {γ}_{C}} ] & ( 17 b )\end{matrix}$$

When the Weibull density function is fit to the probabilities of the maximum entropy provider tail and the maximum entropy consumer tail, the Weibull cumulative distributions of the provider and consumers are given by

$$\begin{matrix}{PE}_{P} ( x ; {λ}_{P} , {κ}_{P} ) = 1 - exp [ - {( \frac{x}{{λ}_{P}} )}^{{κ}_{P}} ] & ( 18 a ) \\ {PE}_{C} ( x ; {λ}_{C} , {κ}_{C} ) = 1 - exp [ - {( \frac{x}{{λ}_{C}} )}^{{κ}_{C}} ] & ( 18 b )\end{matrix}$$

A provider cumulative distribution function PEₚ(x) is used to calculate cumulative distribution values for each metric data value in the set of metric data of the provider M_{P}. The corresponding consumer cumulative distribution function PE_{C}(x) is used to calculate cumulative distribution values for the metric data values in each set of metric data M_{C}_{ₖ} of the consumers. The following pseudocode represents calculation of the cumulative distribution values:

| | |
|---|---|
| 1 | for j in X_{P} do |

| | |
|---|---|
| 2 | M_{Pj} = Metric_{P}(tⱼ) |
| 3 | PE_{Pj} = PE_{P}(M_{Pj}) |

| | |
|---|---|
| 4 | end for |
| 5 | for k in K do |

| | |
|---|---|
| 6 | for j in Xₖ do |

| | |
|---|---|
| 7 | if j in X_{P}, then |

| | |
|---|---|
| 8 | M_{C}_{ₖ}_{,j} = Metric_{C}_{ₖ} (tⱼ) |
| 9 | PE_{P}_{ₖ}_{,j} = PE_{Pj} |
| 10 | PE_{C}_{ₖ}_{,j} = PE_{C} (M_{C}_{ₖ}_{,j}) |

| | |
|---|---|
| 11 | end if |

| | |
|---|---|
| 12 | end for |

| | |
|---|---|
| 13 | end for |
| 14 | return PE_{P}_{_{K}} = {PE_{P}_{ₖ}_{,j}} and PE_{C}_{ₖ} = {PE_{C}_{ₖ}_{,j}} |

In line 3, the quantity PEₚ(M_{Pj}) may be calculated using a Gumbel cumulative distribution PE_{P}(M_{Pj}; α_{P}, β_{P}) with the parameters α_{P} and β_{P} obtained from fitting the Gumbel probability density function to the histogram of the provider tail. Alternatively, the PE_{P}(M_{Pj}) may be calculated using a Frechet cumulative distribution PE_{P}(M_{Pj}; γ_{P}, m_{P}, s_{P}) with the parameters γ_{P}, m_{P}, and s_{P} obtained from fitting the Frechet probability density function to the histogram of the provider tail. Alternatively, the PE_{P}(M_{Pj}) may be calculated using a Weibull cumulative distribution PE_{P}(M_{Pj}; λ_{P}, κ_{P}) with the parameters λ_{P} and κ_{P} obtained from fitting the Weibull probability density function to the histogram of the provider tail. In line 10, the quantity PE_{C}(M_{C}_{ₖ}_{,j}) may be calculated using a Gumbel cumulative distribution PE_{C}(N_{C}_{ₖ}_{,j};α_{C},β_{C}) with the parameters α_{C} and β_{C} obtained from fitting the Gumbel probability density function to the histogram of the consumer tail. Alternatively, the PE_{C}(M_{C}_{ₖ}_{,j}) may be calculated using a Frechet cumulative distribution PE_{C}(M_{C}_{ₖ}_{,j}; γ_{C}, m_{C}, s_{C}) with the parameters γ_{C}, m_{C}, and s_{C} obtained from fitting the Frechet probability density function to the histogram of the consumer tail. Alternatively, the PE_{C}(M_{C}_{ₖ}_{,j}) may be calculated using a Weibull cumulative distribution PE_{C}(M_{C}_{ₖ}_{,j}; λ_{C},κ_{C}) with the parameters λ_{C} and κ_{C} obtained from fitting the Weibull probability density function to the histogram of the consumer tail.

Once the cumulative distributions PE_{P}_{_{K}} and PE_{C}_{ₖ} have been calculated for the provider and one of the consumers, extreme correlation between the provider and the consumer may be determined by calculating one or more of the following correlated-extreme behavior metrics. In one implementation, for each consumer Cₖ in C, an average probability correlated-extreme behavior metric may be calculated as follows:

$${CEBD}_{ave , {C}_{k}} = \frac{1}{{X}_{k}} {\sum }_{j = 1}^{{X}_{k}} {PE}_{{C}_{k} , j} \qquad ( 19 )$$

In another implementation, a correlation-coefficient correlated-extreme behavior metric may be calculated for PE_{P} and PE_{C}_{ₖ} as follows:

$${CEBD}_{CC , {C}_{k}} = \frac{{\sum }_{j = 1}^{{X}_{k}} ( {PE}_{{C}_{k} , j} - {\overline{PE}}_{{C}_{k}} ) ( {PE}_{{P}_{k} , j} - {\overline{PE}}_{{P}_{K}} )}{\sqrt{{\sum }_{j = 1}^{{X}_{k}} {( {PE}_{{C}_{k} , j} - {\overline{PE}}_{{C}_{k}} )}^{2}} \sqrt{{\sum }_{j = 1}^{{X}_{k}} {( {PE}_{{P}_{k} , j} - {\overline{PE}}_{{P}_{k}} )}^{2}}} \\ where \\ {\overline{PE}}_{{C}_{k}} = \frac{1}{{X}_{k}} {\sum }_{j = 1}^{{X}_{k}} {PE}_{{C}_{k} , j} ; and \\ {\overline{PE}}_{{P}_{k}} = \frac{1}{{X}_{k}} {\sum }_{j = 1}^{{X}_{k}} {PE}_{{P}_{k} , j} . \qquad ( 20 )$$

In another implementation, a threshold-based correlated-extreme behavior metric may be a count of the number of PE_{P}_{_{k,j}} and PE_{C}_{ₖ}_{,j} that exceed corresponding thresholds as follows:

$${CEBD}_{thresh , {C}_{k }} = {\sum }_{j = 1}^{{X}_{k}} Count ( j ) \\ where \\ Count ( j ) = \{ \begin{matrix}1 & {PE}_{{P}_{k} , j} > {Th}_{P} and {PE}_{{C}_{k} , j} > {Th}_{C} \\ 0 & {PE}_{{P}_{k} , j} \leq {Th}_{P} or {PE}_{{C}_{k} , j} \leq {Th}_{C}\end{matrix} ; \qquad ( 21 )$$

Th_{C} is a consumer cumulative distribution threshold; and
Th_{P} is a provider cumulative distribution threshold.
   When the correlated-extreme behavior metric of Equation (19), (20), or (21) is greater than a correlated-extreme threshold, Th_{CEBD}, the consumer Cₖ may be identified as a correlated-extreme behavior consumer and remedial action may be taken. For example, if the consumer is a VM the recommendation may be to migrate the consumer to a different server computer. If the consumer is a server computer, the recommendation may to take the server computer off line for trouble shooting. If the consumer is a cluster of server computers, the recommendation may be to take the cluster off line for trouble shooting.

One or more of the correlated-extreme behavior metrics of Equations (19)-(21) may be used to rank order the consumers that are correlated with the provider. For example, a selected number of VMs with the highest rank correlated-extreme behavior metrics may be migrated to other server computers. When a correlated-extreme behavior metric is greater than a corresponding threshold, the consumer may be identify for a course of action. For example, a server computer with a correlated-extreme behavior metric that is greater than a threshold may be taken off line for troubleshooting.

A linear combination of the correlated-extreme behavior metrics represented in Equations (19)-(21) may be used to calculate a combined correlated-extreme behavior metric in order to evaluate correlated extreme behavior of the consumers with the provider:

CEBD_{comb,C}_{ₖ}=w₁×CEBD_{ave,C}_{ₖ}+w₂×CEBD_{CC,C}_{ₖ}+w₃×CEBD_{thresh,C}_{ₖ} (22)

where w₁, w₂, and w₃ are weights.

The weights w₁, w₂, and w₃ may be selected in order to place a greater importance on a particular correlated-extreme behavior metric and less importance on another correlated-extreme behavior metric. One or more of the weights may be set equal to zero in order to exclude use of a particular correlated-extreme behavior metric. When CEBD_{comb}>Thₜₒₜ, where Thₜₒₜ is a total correlated-extreme threshold, the consumer Cₖ may be identified as having extreme correlated behavior with the provider and appropriate action taken, such as migrating a VM to another server computer or taking a server computer or cluster of server computers off line in order to identify the source of the problem.

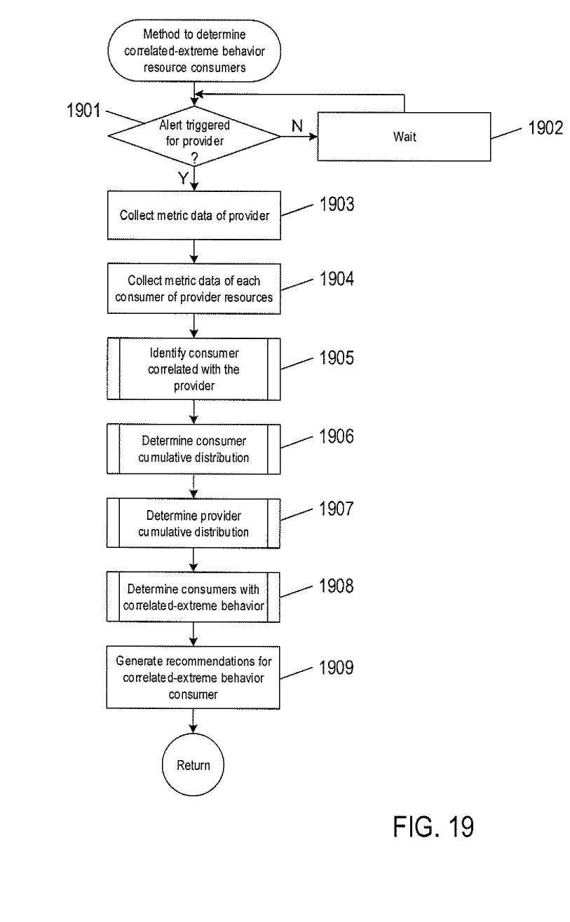

FIGS. 19-23 show control-flow diagrams of a method to determine correlated-extreme behavior of data center resource consumers. When an alert indicating unusual behavior at a provider is triggered, metric data is collected for the provider and consumers that use the resources of the provider. The methods described below identify the consumers that exhibit correlated-extreme behavior with the behavior of the provider. In particular, the methods narrow the search for correlated-extreme behaving consumers when the provider exhibits unexpected or extreme behavior. As a result, system administrators may be able to find a root cause of the problem and fix the problem when the alert is triggered and remedial action may be taken to correct the problem.

FIG. 19 shows a control-flow diagram of a method to determine correlated-extreme behavior of data center resource consumers. In decision block 1901, when an alert is trigger for a provider, control flows to block 1902. The alert may be the result of a metric, such average CPU usage, CPU contention, and average memory usage, generated by the provider violating a threshold. Otherwise, the method waits in block 1902 for period of time. In block 1903, a set of metric data of a provider is collected as described above with reference to Equation (1). In block 1904, sets of metric data of one or more consumers of the computational resources provided to the consumers by the provider are collected as described above with reference to Equation (2). The sets of metric data are the same type of metric data. For example, the sets of metric data may be average-CPU usage, CPU contention, or average memory usage. In block 1905, a routine “identify consumers correlated with the provider” is called to determine which consumers are correlated with the provider based the sets of metric data of the consumers and the set of metric data of the provider. In block 1906, a routine “determine a consumer cumulative distribution” is called to determine a consumer cumulative distribution of the consumers that are correlated with the provider. In block 1907, a routine “determine a provider cumulative distribution” is called to determine a provider cumulative distribution of the provider. In block 1908, a routine “determine consumers with correlated-extreme behavior” is called to determine which of the consumers that are correlated with the provider are correlated-extreme behavior consumers based on the consumer cumulative distribution and the provider cumulative distribution. In block 1909, recommendations may be generated to handle the correlated-extreme behavior consumers. For example, the correlated-extreme behavior consumers may be rank ordered in order to identify the consumers that exhibit the greatest extreme behavior. When the correlated-extreme behavior consumers are VMs, the recommendation may be to migrate the VMs to other server computers that can accommodate the VMs. When the correlated-extreme behavior consumers are server computers or computer clusters the server computers or computer clusters may be subjected to troubleshooting in order to identify any problems.

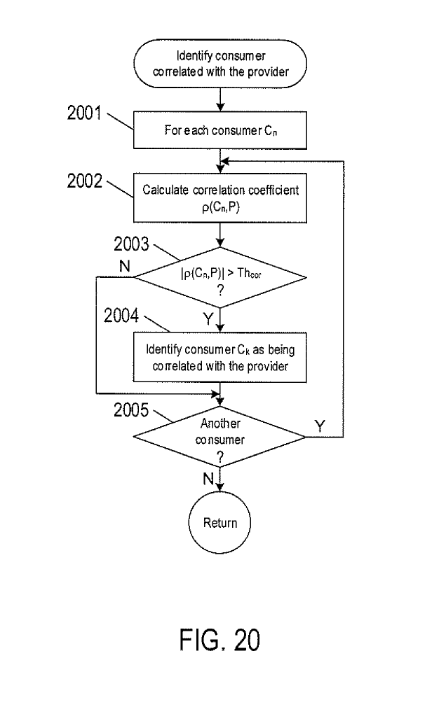

FIG. 20 shows a control-flow diagram of the routine “identify consumers correlated with the provider” called in block 1903 of FIG. 19. A loop beginning with block 2001 repeats the computational operations of blocks 2002-2005 for each consumer. In block 2002, a correlation coefficient is calculated between the set of metric data of the consumer and the set of metric data of the provider, as described above with reference to Equation (3). In decision block 2003, when the absolute value of the correlation coefficient is greater than a correlation threshold, as described above with reference to Equation (4a), control flows to block 2004. Otherwise, control flows to a decision block 2005 in which another consumer is considered. In block 2004, the consumer is identified as being correlated with the provider.

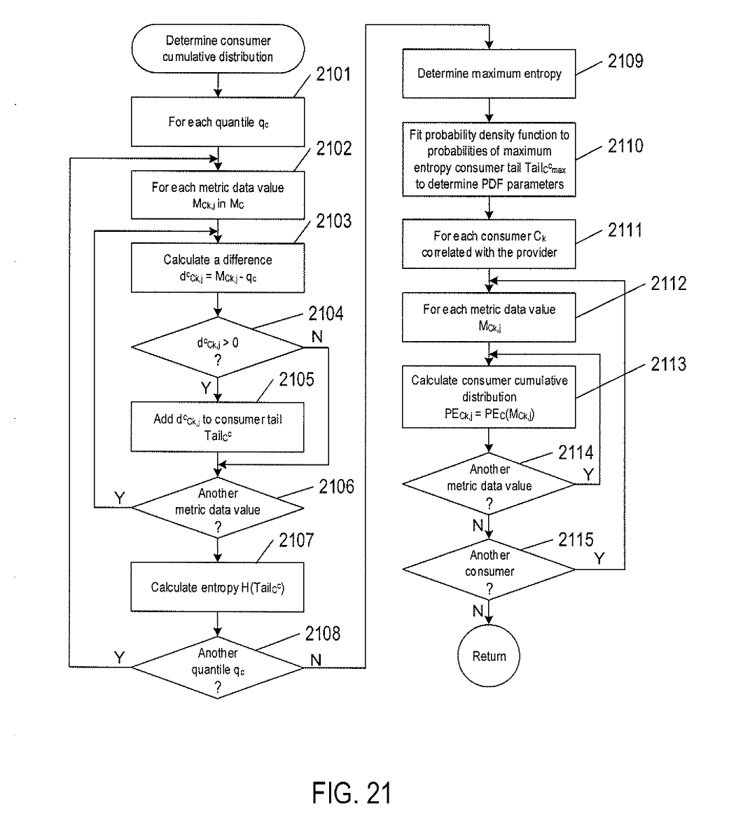

FIG. 21 shows a control-flow diagram of the routine “determine a consumer cumulative distribution” called in block 1906 of FIG. 19. A loop beginning with block 2101 repeats the operations of blocks 2102-2108 for each quantile q_{c} with a quantile index c selected from a subinterval cₘᵢₙ≤c≤cₘₐₓ of the interval [0,1]. A loop beginning with block 2102 repeats the operations of blocks 2103-2106 for each metric data value M_{C}_{ₖ}_{,j} in the set of correlated consumer metric data M_{C}. In block 2103, a difference between from the metric data value to a quantile is calculated as described above with reference to Equation (9a). In decision block 2104, when the difference is greater than zero as described above with reference to Equation (9a), control flows to block 2105. Otherwise, control flows to decision block 2106. In block 2105, the difference is added to a consumer tail Tail_{C}^{c} for the quantile q_{c}. In decision block 2106, blocks 2104-2106 are repeated for another metric data value M_{C}_{ₖ}_{,j} in the set M_{C}. In block 2107, entropy H(Tail_{C}^{c}) is calculated for the consumer tail Tail_{C}^{c}, as described above with reference to Equations (10b) and (11b). In decision block 2108, blocks 2102-2107 are repeated for another quantile. In block 2109, a maximum entropy is determined and the corresponding consumer tail is identified as the maximum entropy consumer trail Tail_{C,max}^{c}. In block 2110, a probability density function is fit to the probabilities of the maximum entropy consumer trail Tail_{C,max}^{c} as described above with reference to FIG. 18B. A loop beginning with block 2111 repeats the operations of blocks 2112-2114 for each consumer correlated with the provider. A loop beginning with block 2112 repeats the operations of block 2113 for each metric data value of the consumer correlated with the provider. In block 2113, a consumer cumulative distribution value is calculated from the metric data value as described above with reference to line 10 of the pseudocode above. In decision block 2114, block 2113 is repeated for another metric data value. In decision block 2115, blocks 2112-2114 are repeated for another consumer.

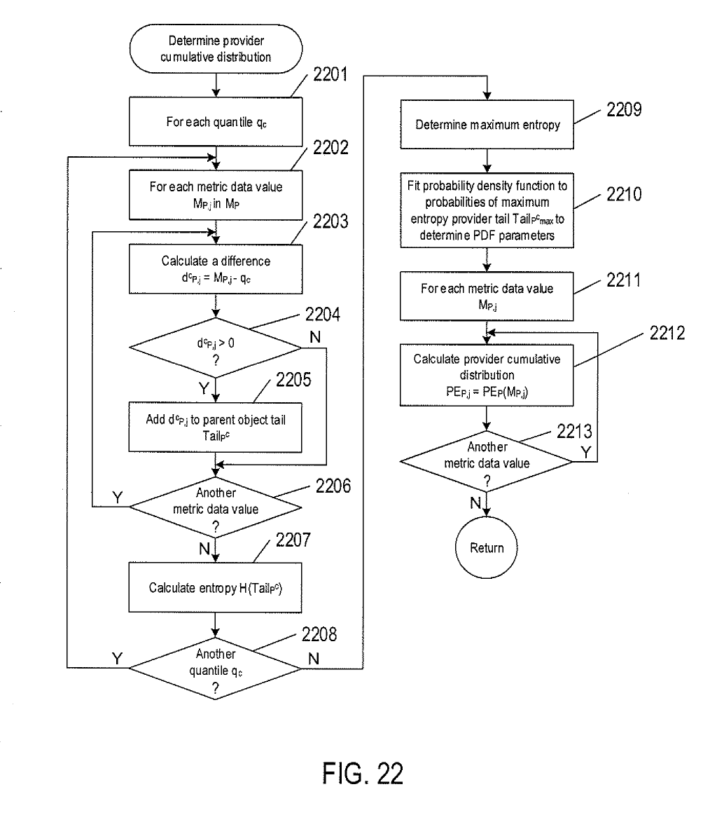

FIG. 22 shows a control-flow diagram of the routine “determine a provider cumulative distribution” called in block 1907 of FIG. 19. A loop beginning with block 2102 repeats the operations of blocks 2202-2208 for each quantile qᵣ with a quantile index c selected from a subinterval cₘᵢₙ≤c≤cₘₐₓ of the interval [0,1]. A loop beginning with block 2202 repeats the operations of blocks 2203-2206 for each metric data value M_{P,j} of the set of metric data of the provider M_{P}. In block 2203, a difference between from the metric data value to a quantile is calculated as described above with reference to Equation (8a). In decision block 2204, when the difference is greater than zero as described above with reference to Equation (8a), control flows to block 2205. Otherwise, control flows to decision block 2206. In block 2205, the difference is added to a provider tail Tail_{P}^{c}. In decision block 2206, blocks 2203-2205 are repeated for another metric data value. In block 2207, entropy H(Tail_{P}^{c}) is calculated for the provider tail Tail_{P}^{c}, as described above with reference to Equations (10a) and (11a). In decision block 2208, blocks 2202-2207 are repeated for another quantile. In block 2209, a maximum entropy is determined and the corresponding provider tail is identified as the maximum entropy provider trail Tail_{P,max}^{c}. In block 2210, a probability density function is fit to the probabilities of the maximum entropy provider trail Tail_{P,max}^{c} as described above with reference to FIG. 18A. A loop beginning with block 2211 repeats the operations of block 2212 for each metric data value. In block 2212, a provider cumulative distribution value is calculated from the metric data value as described above with reference to line 3 of the pseudocode above. In decision block 2213, block 2212 is repeated for another metric data value.

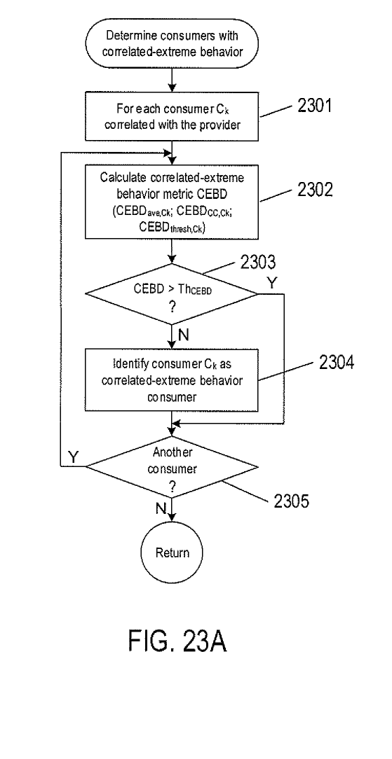

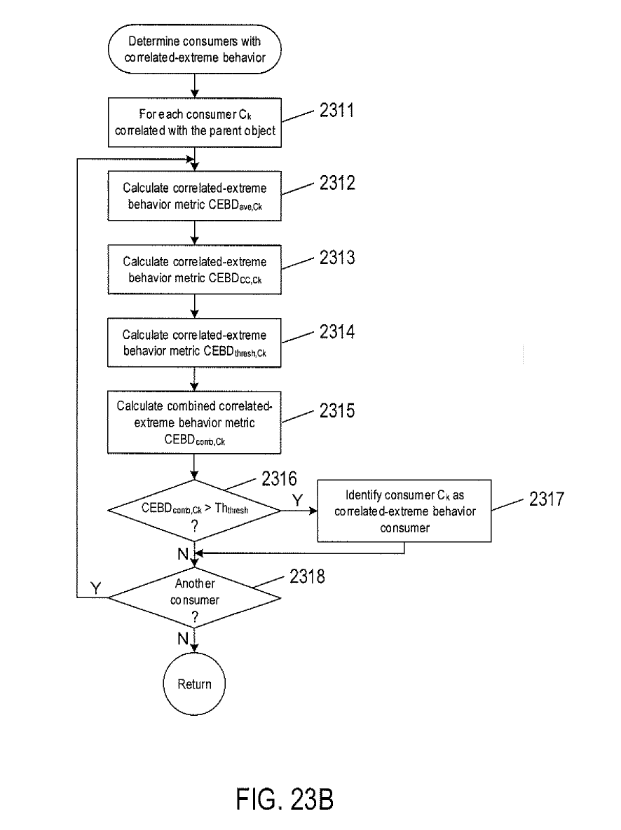

FIG. 23A shows a control-flow diagram of the routine “determine consumers with correlated-extreme behavior” called in block 1908 of FIG. 19. A loop beginning with block 2301 repeats the operations represented by blocks 2302-2305 for each consumer correlated with the provider. In block 2302, a correlated-extreme behavior metric, CEBD_{C}_{ₖ}, is calculated. In one implementation, the correlated-extreme behavior metric may be an average probability correlated-extreme behavior metric as described above with reference to Equation (19) (i.e., CEBD_{C}_{ₖ}=CEBD_{ave,C}_{ₖ}). In another implementation, the correlated-extreme behavior metric may be a correlation-coefficient correlated-extreme behavior metric as described above with reference to Equation (20) (i.e., CEBD_{C}_{ₖ}=CEBD_{CC,C}_{ₖ}. In still another implementation, the correlated-extreme behavior metric may be a threshold-based correlated-extreme behavior metric as described above with reference to Equation (21) (i.e., CEBD_{C}_{ₖ}=CEBD_{thresh,C}_{ₖ}). In block 2303, when the correlated-extreme behavior metric is greater than a correlated-extreme threshold, Th_{CEBD}, the consumer may be identified as a correlated-extreme behavior consumer in block 2304. Otherwise, control flows to block 2305 and another consumer that is correlated with the provider is considered.

FIG. 23B shows a control-flow diagram of the routine “determine consumers with correlated-extreme behavior” called in block 1908 of FIG. 19. A loop beginning with block 2311 repeats the operations represented by blocks 2312-2318 for each consumer correlated with the provider. In block 2312, an average probability correlated-extreme behavior metric, CEBD_{ave,C}_{ₖ}, is calculated as described above with reference to Equation (19). In block 2313, a correlation-coefficient correlated-extreme behavior metric, CEBD_{CC,C}_{ₖ}, is calculated as described above with reference to Equation (20). In block 2314, a threshold-based correlated-extreme behavior metric, CEBD_{thresh,C}_{ₖ}, is calculated as described above with reference to Equation (21). In block 2315, a combined correlated-extreme behavior metric is calculated as described above with reference to Equation (22). In block 2316, when the combined correlated-extreme behavior metric is greater than a total correlated-extreme threshold, Thₜₒₜ, the consumer may be identified as a correlated-extreme behavior consumer in block 2317. Otherwise, control flows to block 2218 and another consumer that is correlated with the provider is considered.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method to determine correlated-extreme behavior consumers of computational resources of a data center, the method comprising:
collecting metric data of consumers of computational resources of a provider and metric data of the provider in a recent period of time;
correlation filtering the consumers in order to identify a subset of the consumers that are related to the provider over the recent period of time based on correlations between the metric data of each consumer with the metric data of the provider;
determining a consumer cumulative distribution based on the metric data of the subset of consumers;
determining a provider cumulative distribution based on the metric data of the provider;
determining which consumers of the subset of consumers are correlated-extreme behavior consumers based on the consumer cumulative distribution and the provider cumulative distribution; and
generating recommendations to correct the correlated-extreme behavior consumers.

2. The method of claim 1, wherein correlation filtering comprises:
for each consumer, calculating a correlation coefficient between the metric data of the consumer and the metric data of the provider; and
forming the subset of consumers from consumers having correlation coefficients that are greater than a correlation threshold.

3. The method of claim 1, wherein determining the consumer cumulative distribution comprises:
for each of a number of different quantiles, forming a consumer tail from differences between the metric data of the consumer and the quantile, the differences being greater than zero;
calculating an entropy for each of the consumer tails;
determining a maximum entropy of the entropies;
fitting a probability density function to the consumer tail having the maximum entropy; and
calculating the consumer cumulative distribution for each consumer in the subset of consumers based on parameters of the probability density function.

4. The method of claim 1, wherein determining the provider cumulative distribution comprises:
for each of a number of different quantiles, forming a number of provider tails from differences between the metric data of the provider and the quantile, the differences being greater than zero;
calculating an entropy for each of the provider tails;
determining a maximum entropy of the entropies;
fitting a probability density function to the provider tail having the maximum entropy; and
calculating the provider cumulative distribution based on parameters of the probability density parameters.

5. The method of claim 1, wherein determining which consumers of the subset of consumers are correlated-extreme behavior consumers comprises:
for each consumer in the subset of consumers,
calculating an average probability correlated-extreme behavior metric based on the consumer cumulative distribution of the consumer; and
when the average probability correlated-extreme behavior metric is greater than a correlated-extreme threshold, identifying the consumer as a correlated-extreme behavior consumer.

6. The method of claim 1, wherein determining which consumers of the subset of consumers are correlated-extreme behavior consumers comprises:
for each consumer in the subset of consumers,
calculating a correlation-coefficient correlated-extreme behavior metric based on the consumer cumulative distribution of the consumer and the provider cumulative distribution; and
when the correlation-coefficient correlated-extreme behavior metric is greater than a correlated-extreme threshold, identifying the consumer as a correlated-extreme behavior consumer.

7. The method of claim 1, wherein determining which consumers of the subset of consumers are correlated-extreme behavior consumers comprises:
for each consumer in the subset of consumers,
calculating a threshold-based correlated-extreme behavior metric based on the consumer cumulative distribution associated with the consumer and the provider cumulative distribution; and
when the threshold-based correlated-extreme behavior metric is greater than a correlated-extreme threshold, identifying the consumer as a correlated-extreme behavior consumer.

8. A system to determine correlated-extreme behavior consumers of computational resources of a data center, the system comprising:
one or more processors;
one or more data-storage devices; and
machine-readable instructions stored in the one or more data-storage devices that when executed using the one or more processors controls the system to carry out
collecting metric data of consumers of computational resources of a provider and metric data of the provider in a recent period of time;
correlation filtering the consumers in order to identify a subset of the consumers that are related to the provider over the recent period of time based on correlations between the metric data of each consumer with the metric data of the provider;
determining a consumer cumulative distribution based on the metric data of the subset of consumers;
determining a provider cumulative distribution based on the metric data of the provider;
determining which consumers of the subset of consumers are correlated-extreme behavior consumers based on the consumer cumulative distribution and the provider cumulative distribution; and
generating recommendations to correct the correlated-extreme behavior consumers.

9. The system of claim 8, wherein correlation filtering comprises:
for each consumer, calculating a correlation coefficient between the metric data of the consumer and the metric data of the provider; and
forming the subset of consumers from consumers having correlation coefficients that are greater than a correlation threshold.

10. The system of claim 8, wherein determining the consumer cumulative distribution comprises:
for each of a number of different quantiles, forming a number of consumer tails from differences between the metric data of the consumer and the quantile, the differences being greater than zero;
calculating an entropy for each of the consumer tails;
determining a maximum entropy of the entropies;
fitting a probability density function to the consumer tail having the maximum entropy; and
calculating the consumer cumulative distribution for each consumer in the subset of consumers based on parameters of the probability density function.

11. The system of claim 8, wherein determining the provider cumulative distribution comprises:
forming a number of provider tails from differences between the metric data of the provider and a number of different quantiles, the differences being greater than zero;
calculating an entropy for each of the provider tails;
determining a maximum entropy of the entropies;
fitting a probability density function to the provider tail having the maximum entropy; and
calculating the provider cumulative distribution based on parameters of the probability density parameters.

12. The system of claim 8, wherein determining which consumers of the subset of consumers are correlated-extreme behavior consumers comprises:
for each consumer in the subset of consumers,
calculating an average probability correlated-extreme behavior metric based on the consumer cumulative distribution of the consumer; and
when the average probability correlated-extreme behavior metric is greater than a correlated-extreme threshold, identifying the consumer as a correlated-extreme behavior consumer.

13. The system of claim 8, wherein determining which consumers of the subset of consumers are correlated-extreme behavior consumers comprises:
for each consumer in the subset of consumers,
calculating a correlation-coefficient correlated-extreme behavior metric based on the consumer cumulative distribution of the consumer and the provider cumulative distribution; and
when the correlation-coefficient correlated-extreme behavior metric is greater than a correlated-extreme threshold, identifying the consumer as a correlated-extreme behavior consumer.

14. The system of claim 8, wherein determining which consumers of the subset of consumers are correlated-extreme behavior consumers comprises:
for each consumer in the subset of consumers,
calculating a threshold-based correlated-extreme behavior metric based on the consumer cumulative distribution associated with the consumer and the provider cumulative distribution; and
when the threshold-based correlated-extreme behavior metric is greater than a correlated-extreme threshold, identifying the consumer as a correlated-extreme behavior consumer.

15. A non-transitory computer-readable medium encoded with machine-readable instructions that implement a method carried out by one or more processors of a computer system to perform the operations of
collecting metric data of consumers of computational resources of a provider and metric data of the provider in a recent period of time;
correlation filtering the consumers in order to identify a subset of the consumers that are related to the provider over the recent period of time based on correlations between the metric data of each consumer with the metric data of the provider;
determining a consumer cumulative distribution based on the metric data of the subset of consumers;
determining a provider cumulative distribution based on the metric data of the provider;
determining which consumers of the subset of consumers are correlated-extreme behavior consumers based on the consumer cumulative distribution and the provider cumulative distribution; and
generating recommendations to correct the correlated-extreme behavior consumers.

16. The medium of claim 15, wherein correlation filtering comprises:
for each consumer, calculating a correlation coefficient between the metric data of the consumer and the metric data of the provider; and
forming the subset of consumers from consumers having correlation coefficients that are greater than a correlation threshold.

17. The medium of claim 15, wherein determining the consumer cumulative distribution comprises:
for each of a number of different quantiles, forming a number of consumer tails from differences between the metric data of the consumer and the quantile, the differences being greater than zero;
calculating an entropy for each of the consumer tails;
determining a maximum entropy of the entropies;
fitting a probability density function to the consumer tail having the maximum entropy; and
calculating the consumer cumulative distribution for each consumer in the subset of consumers based on parameters of the probability density function.

18. The medium of claim 15, wherein determining the provider cumulative distribution comprises:
forming a number of provider tails from differences between the metric data of the provider and a number of different quantiles, the differences being greater than zero;
calculating an entropy for each of the provider tails;
determining a maximum entropy of the entropies;
fitting a probability density function to the provider tail having the maximum entropy; and
calculating the provider cumulative distribution based on parameters of the probability density parameters.

19. The medium of claim 15, wherein determining which consumers of the subset of consumers are correlated-extreme behavior consumers comprises:
for each consumer in the subset of consumers,
calculating an average probability correlated-extreme behavior metric based on the consumer cumulative distribution of the consumer; and
when the average probability correlated-extreme behavior metric is greater than a correlated-extreme threshold, identifying the consumer as a correlated-extreme behavior consumer.

20. The medium of claim 15, wherein determining which consumers of the subset of consumers are correlated-extreme behavior consumers comprises:
for each consumer in the subset of consumers,
calculating a correlation-coefficient correlated-extreme behavior metric based on the consumer cumulative distribution of the consumer and the provider cumulative distribution; and
when the correlation-coefficient correlated-extreme behavior metric is greater than a correlated-extreme threshold, identifying the consumer as a correlated-extreme behavior consumer.

21. The medium of claim 15, wherein determining which consumers of the subset of consumers are correlated-extreme behavior consumers comprises:
for each consumer in the subset of consumers,
calculating a threshold-based correlated-extreme behavior metric based on the consumer cumulative distribution associated with the consumer and the provider cumulative distribution; and
when the threshold-based correlated-extreme behavior metric is greater than a correlated-extreme threshold, identifying the consumer as a correlated-extreme behavior consumer.
